(19) United States
(12) Patent Application Publication
(10) Pub. No.: US 2011/0130974 A1
(43) Pub. Date: Jun. 2, 2011

(54) METHOD AND APPARATUS FOR ROAD SURFACE FRICTION ESTIMATION BASED ON THE SELF ALIGNING TORQUE

(75) Inventors: Simon YNGVE, Goteborg (SE); Youssef GHONEIM, Oakland, CA (US)

(73) Assignee: GM GLOBAL TECHNOLOGY OPERATIONS, INC., Detroit, MI (US)

(21) Appl. No.: 12/876,965

(22) Filed: Sep. 7, 2010

(30) Foreign Application Priority Data
Sep. 9, 2009 (GB) 0915742.1

(51) Int. Cl. G06F 19/00

(52) U.S. Cl. 702/41

(57) ABSTRACT

A method and an apparatus are disclosed for estimating a road surface friction between a road surface and a tire of a vehicle. The method includes, but is not limited to computing, in a slope estimation step, a slope estimate k_sl for a slope of a linear region of a self aligning torque function that is defined by a self aligning torque as a function of a slip angle. The method further includes, but is not limited to deriving a first estimate μ_sl of a road friction coefficient from the slope estimate k_sl, and deciding, in a linearity estimation step, whether a current slope k_op is within the linear region of the self aligning torque function. If it is decided in the linearity estimation step that the current slope k_op is within the linear region of the self aligning torque function, the first estimate μ_sl of the road friction coefficient is output as a second estimate μ_cont of the road friction coefficient.

### CROSS-REFERENCE TO RELATED APPLICATION

This application claims priority to British Patent Application No. 0915742.1, filed Sep. 9, 2009, which is incorporated herein by reference in its entirety.

### TECHNICAL FIELD

The technical field generally relates to road surface friction estimation, and more particularly to methods and apparatus for road surface estimate based on the self aligning torque.

### BACKGROUND

While driving a vehicle, such as a passenger car, the driver may come across different road surfaces, such as asphalt, gravel road, dry, wet, ice, snow, and so on. These and other types of road surfaces are characterized by different road friction coefficients μ, affecting tire grip and vehicle stability.

For a number of reasons such as driving economy, comfort and performance, it is important that the vehicle can be operated in a fashion that permits it to quickly respond to various road surface conditions at any time.

One way of approaching this problem is to make use of estimations of momentary road surface friction. In the prior art, different methods have been disclosed for estimating momentary road surface friction. These methods can be classified in different categories. A first category consists of methods for computing the momentary road surface friction coefficient μ based on motion sensor data and a suitable vehicle dynamics model. A second category uses signals of force sensors. In this category, various methods are known that use a lateral force or a self aligning torque for the estimation of a road friction coefficient. A third category of methods use a preview camera that recognizes road conditions ahead of the vehicle and various infrastructure information.

At least one object of the application is to provide an improved vehicle. In addition, it other objects, desirable features, and characteristics, will become apparent from the subsequent summary and detailed description, and the appended claims, taken in conjunction with the accompanying drawings and this background.

### SUMMARY

The present application discloses an improved method and device for estimating a road surface friction between a road surface and a tire of a vehicle. In a slope estimation step, a slope estimate k_sl is computed for a slope of a linear region of a self aligning torque function. The self aligning torque function is defined by a self aligning torque of a steered wheel as a function of a slip angle of a steered wheel. Preferentially, the estimate is given by an estimate of the current self aligning torque divided by the current slip angle. An update formula of a Kalman filter may be used to generate an estimate from one or more observation variables. In particular, the observation variables may be given by the self aligning torque and the slip angle or by a quotient of them.

From the slope estimate k_sl a first estimate μ_sl of a road friction coefficient μ is derived. In a linearity estimation step it is decided, whether a current slope k_op is within the linear region of the self aligning torque function. The current slope k_op is computed by an estimate of the current derivative of the self aligning torque with respect to the slip angle. An update formula of a Kalman filter may be used to generate the estimate from one or more observation variables. In particular, the observation variables may be given by a time derivative of the self aligning torque and a time derivative of the slip angle.

If it is decided in the linearity estimation step that the current slope k_op is within the linear region of the self aligning torque function, the first estimate μ_sl of the road friction coefficient as a second estimate μ_cont of the road friction coefficient. If, on the other hand it is decided in the linearity estimation step that the current slope k_op is not within the linear region of the self aligning torque function, the computation of the slope estimate k_sl is halted.

It is decided that the current slope k_op is within the nonlinear region of the self aligning torque function if k_op falls below a lower threshold k_op threshold_low and it is decided that the current slope k_op is within the linear region of the self aligning torque function if the current slope k_op rises above an upper threshold k_op threshold_high, wherein k_op threshold_low<k_op threshold_high.

The application furthermore discloses a computer executable program code for executing the steps of a method according to the application and a computer readable medium which comprises the computer executable program code.

### BRIEF DESCRIPTION OF THE DRAWINGS

The present invention will hereinafter be described in conjunction with the following drawing figures, wherein like numerals denote like elements, and:

FIG. 1 illustrates a dynamic model for a vehicle;

FIG. 2 illustrates measurements of the self aligning torque versus the slip angle for various road conditions;

FIG. 3 illustrates the relationship between self aligning torque and slip angle and between lateral force and slip angle for a given road surface friction;

FIG. 4 illustrates a flow diagram of an estimation algorithm for a road friction coefficient; and

FIG. 5 illustrates a road friction estimating apparatus.

### DETAILED DESCRIPTION

The following detailed description is merely exemplary in nature and is not intended to limit application and uses. Furthermore, there is no intention to be bound by any theory presented in the background or summary or the following detailed description. In addition, in the following description, details are provided to describe the embodiments of the application (invention). It shall be apparent to one skilled in the art, however, that the embodiments may be practiced without such details.

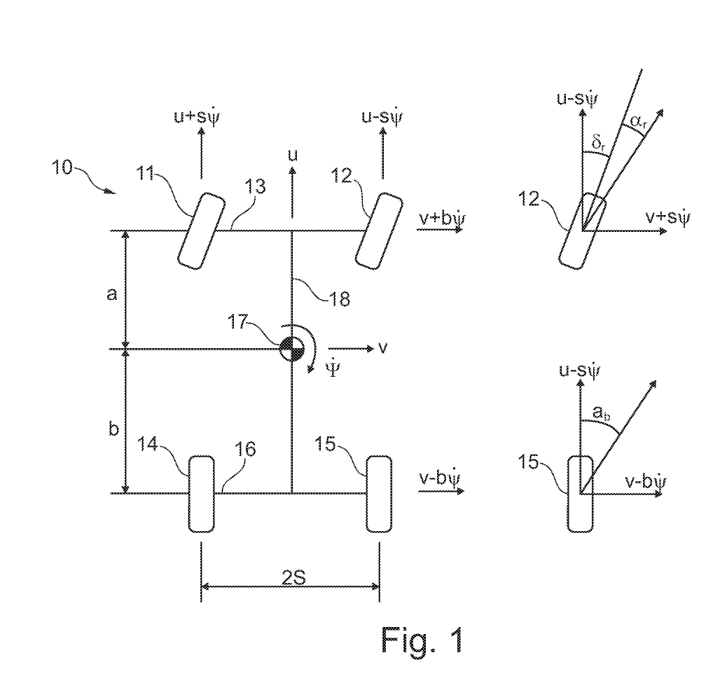

FIG. 1 shows a dynamic model of a vehicle. A schematic model of a vehicle 10 is shown in a plane which is parallel to a road surface. The vehicle 10 has two front wheels 11, 12 which are a distance s apart along a front axis 13 and two rear wheels 14, 15 which are the same distance s apart along a rear axis 16. The front axis 13 has a distance a from a center of gravity 17 of the vehicle and the rear axis 16 has a distance b from the center of gravity 17. The vehicle 10 moves forward with a forward velocity u, moves sideways with a lateral velocity v and yaws around its center of gravity 17 with a yaw rate \dot{Ψ}. If the vehicle 10 yaws to the right, the forward velocity of the left wheels 11, 14 is increased by s\dot{Ψ} and the forward velocity of the right wheels 12, 15 is decreased by the same amount. Also, the lateral velocity of the front wheels 11, 12 is increased by a a\dot{Ψ} and the lateral velocity of the rear wheels 14, 15 is decreased by b\dot{Ψ}.

The right side of FIG. 1 shows a schematic view of the right front wheel 12 and the right rear wheel 15. The horizontal orientation of the wheels usually does not coincide with the direction of the wheels but differs from it by a slip angle α. The orientation of the right front wheel 12 relative to a longitudinal axis 18 of the car is given by a right steering angle δᵣ. The direction of the wheel velocity of the right front wheel 12 is given by the velocity vector (v+a\dot{Ψ}, u−s\dot{Ψ}). The direction of the velocity vector differs by a slip angle αᵣ from the orientation of the right front wheel 12. For the back wheels 14, 15, which are not steered wheels in this model, the steering angle δ is zero and the slip angle α_{b} is equal to the direction of the wheel velocity vectors (v−b\dot{Ψ}, u+s\dot{Ψ}) and (v−b\dot{Ψ}, u−s\dot{Ψ}). In a simplified model, the right and left steering angles δᵣ, δᵢ are assumed to be equal to a steering angle δ. The right and left slip angles are then given by

$${α}_{r} = δ - arc tan ( \frac{v + a \dot{ψ}}{u + s \dot{ψ}} )$$

$$and$$

$${α}_{l} = δ - arc tan ( \frac{v + a \dot{ψ}}{u + s \dot{ψ}} ) ,$$

respectively.

The determination of the slip angles is thus reduced to the determination of the steering angle and the movement of the center of gravity in the horizontal plane which is determined by the velocity (u, v) and the yaw rate \dot{Ψ}. The movement of the center of gravity 17 can in turn be determined by using output signals of velocity and acceleration sensors and a specialized yaw rate sensor.

When the vehicle 10 of FIG. 1 corners, the tires of the wheels 11, 12, 14, 15 experience a self aligning torque M_z which tends to align the wheels 11, 12, 14, 15 in the horizontal plane. The self aligning torque is dependant on the slip angle α of a wheel and other factors such as the camber angle, the tire shape and the road friction. Through the steered front wheels 11, 12, the self aligning torque M_z is transmitted to the steering mechanism of the vehicle 10.

For a hydraulic power steering, a calculation of the self aligning torque on the front wheels can be performed according to the following formula:

M_{z}_{_{—}}_{L}+M_{z}_{_{—}}_{R}=|p_{HPSR}−p_{HPSL}|A_{HPS}d_{TR}_{_{—}}_{wc}+T_{SW} (1)

Herein, M_z_L and M_z_R are the self aligning torques on the left and the right wheel, respectively. p_HPSR and p_HPSL are the pressures on the right and the left side of a hydraulic power cylinder and A_HPS is a pressure receiving area of the hydraulic power cylinder. T_SW is the driver's input torque on the steering wheel. The effective moment arm length d_TR_wc is a function of a steering wheel angle. For the calculation of the effective moment arm length d_TR_wc, a small angle approximation is applied for the angle between the rack and the tie rods. The angle between the wheel plane and the tie rods could be compensated for with a steering wheel angle dependant look up table, but can also be approximated to a constant value since calculation is only done on the outer wheel.

For an electric power steering, a signal of a steering torque sensor is used instead of a pressure difference. A supplied current to the electric steering motor may also be used to derive an applied force. If the steering torque is generated by the steering assistance means alone, as in a steer by wire system, the steering wheel torque does not occur in formula (1).

Furthermore, the self aligning torque is influenced by a steering system friction (T_fr) a drive torque (T_d), a toe variation (T_toe) and a camber angle variation (T_camber) and caster, static toe and camber (T_offset). Adding these to equation (1) results in the improved formula

M_{z}_{_{—}}_{L}+M_{z}_{_{—}}_{R}=|p_{HPSR}−p_{HPSL}|A_{HPS}d_{TR}_{_{—}}_{wc}+T_{SW}−T_{fr}−T_{d}−Tₜₒₑ−T_{camber}−T_{offset} (2)

The caster, static toe and camber influence on tie rod forces are treated as a vehicle speed dependant constant offset, as the influence of these is assumed to be minor.

Considering, as an approximation, only the force on the outer steered wheel, equation (2) becomes, for right turns:

M_{z}_{_{—}}_{L}=k_{L}(|p_{HPSR}|A_{HPS}d_{TR}_{_{—}}_{wc}+T_{SW}−T_{fr})−T_{d}−T_{offset}

and for left turns

M_{z}_{_{—}}_{R}=k_{R}(|p_{HPSL}|A_{HPS}d_{TR}_{_{—}}_{wc}+T_{SW}−T_{fr})−T_{d}−T_{offset},

Where k_L, k_R are the side bias depending on load shifts because of vehicle's dynamic motion. The signal T_SW of a steering wheel torque sensor and the signals p_HPSL, p_HPSR of pressure sensors are filtered and centered.

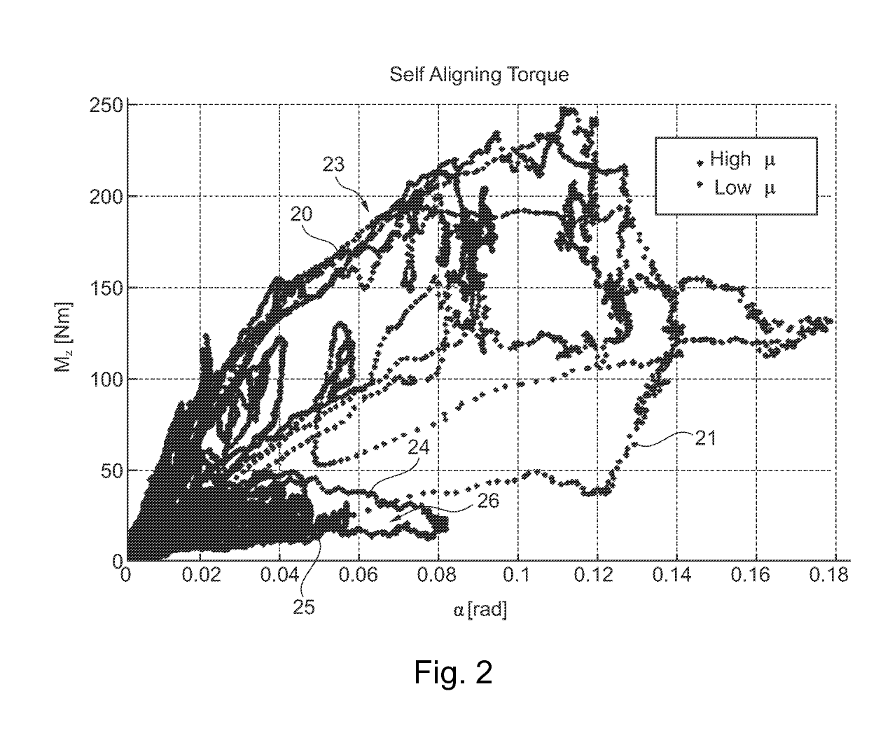

FIG. 2 shows measurements of a self aligning torque of a front wheels versus the slip angle. The measurement points were taken for a road condition with a high road surface friction coefficient μ and a low road surface friction coefficient μ, respectively. For the measurements of FIG. 2, the existing sensors of an electric power steering have been used to determine the self aligning torque. The self aligning torque may be determined in various ways, for example by a steering wheel torque sensor and a steering torque sensor, by strain gauges at the left and the right tie rod or by wheel force transducers. The first method is particularly suitable for a hydraulic or electric power steering. A first upper curve 20 and a first lower curve 21 limits a region 23 of measurement points for a high road friction coefficient μ. A second upper curve 24 and a second lower curve 25 limits a region 26 of measurement points for a low road friction coefficient.

From FIG. 2 it is apparent that the relationship between self aligning torque and slip angle depends on the road surface friction coefficient. Most measurement points of the high μ region 23 lie above the measurement points of the low μ region 26. It can further be seen that the relationship between self aligning torque and slip angle shows hysteresis and random effects.

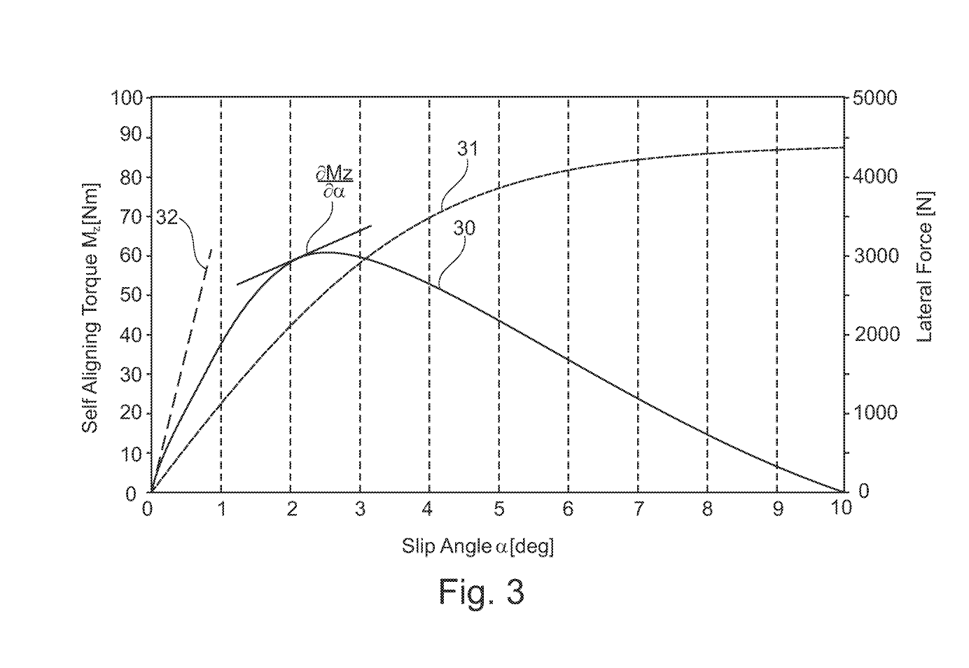

FIG. 3 shows a model calculation for a given road surface friction coefficient μ of a function 30 of the self aligning torque with respect to a slip angle and of a function 31 of a lateral force on a front tire with respect to a slip angle. It can be seen that the self aligning torque M_z saturates for much smaller slip angles α than the lateral force. Furthermore, the relationship between self aligning torque and slip angle is approximately linear for small slip angles, M_z=k_sl α, which is indicated by a linear approximation 32. The slope k_sl of the linear approximation to the curve is dependent on the road surface friction coefficient μ. According to the application, the slope k_sl is used for the determination of the road surface friction coefficient μ.

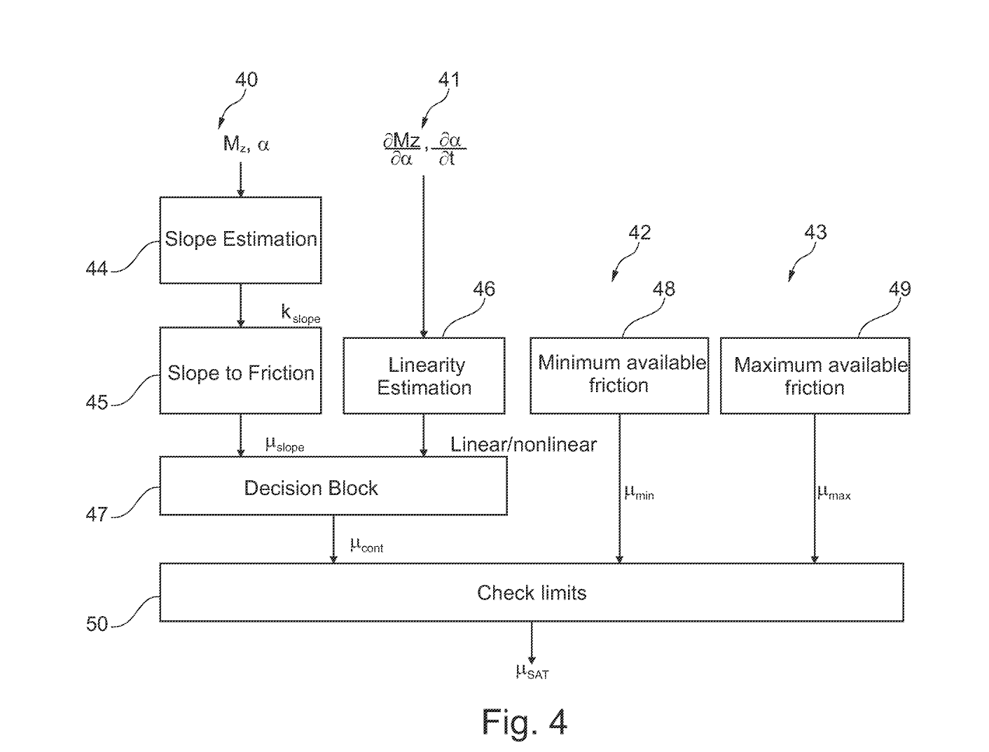

FIG. 4 shows a flow diagram of an algorithm according to the application for determining the road surface friction coefficient μ. The flow diagram comprises for computational threads 40, 41, 42, 43 which can be carried out in parallel. The computational threads comprise an estimation of the slope k_sl, an estimation of the change of the current slope k_op=∂M_{z}/∂α over time and estimations of the minimum and maximum available road surface friction coefficients μ_min and μ_max, respectively.

In the first computational thread 40, an estimate \hat{k}_sl of the slope k_sl is computed in step 44 using a vector (M_z, α) with the components self aligning torque and slip angle as an observation variable in a Kalman filter update formula. The resulting estimate is used to compute an estimate \hat{k}_sl=\hat{M}_{z}/\hat{α} of the slope k_sl as a quotient of the estimated self aligning torque \hat{M}_{z} and the estimated slip angle \hat{α}. Alternatively, the quotient M_z/α may be used as observation variable and the estimate of the quotient as the estimated slope \hat{k}_sl. The validity of the estimate \hat{k}_sl is checked by comparing a covariance matrix of a Kalman filter update formula to a predetermined covariance matrix. If the convergence of the estimates \hat{k}_sl(t) is sufficient, the current estimate is output as new estimate of the slope k_sl. In a next step 45, a look up table is used to convert the slope estimate \hat{k}_sl to an estimate μ_sl of the road surface friction coefficient μ.

In a linearity estimation step 46 of the second computational thread 41, an estimate of the current slope k_op is computed based on the current rate of change ∂M_{z}(t)/∂t of the self aligning torque M_z and the rate of change ∂α(t)/∂t of the slip angle α. The rates of change can be deduced from the sensor values or they can be approximated by finite differences such as the two-point differences M_z(t+1)−M_z(t) and α(t+1)−α(t). A second Kalman Filter is used to produce estimates of the rates of change of the self aligning torque and of the slip angle. The quotient of the two estimates is used as estimate for the current slope k_op=∂M_{z}(t)/∂α.

If the current slope k_op falls below a lower threshold k_op threshold_low it is decided that the nonlinear region of the curve 30 of FIG. 3 has been entered. In this case, the update process of the first thread 40 is halted and the slope estimate \hat{k}_=\hat{M}_{z}/\hat{α} for the linear region is kept on the last computed value. The second computational thread 41, on the other hand, continues to calculate the estimate k_op=∂M_{z}(t)/∂α. If the current slope k_op rises above an upper threshold, k_op threshold_high it is decided, that the linear region has been entered again, and the computational thread 40 is resumed. To account for hysteresis, the upper threshold is greater than the lower threshold, k_op threshold_high>k_op threshold_low. The decision, if the current slope k_op is within the linear region is output as result value of the linearity estimation step 46.

In a decision step 47, it is decided to use the road friction coefficient μ_sl from step 45 as output value μ_cont if it is decided in the linearity estimation step 46 that the current slope k_op is within the linear region and if the estimate of k_sl is a valid estimate according to one of the abovementioned criteria. Otherwise, a stored value of the latest valid estimate μ_sl is used as output value μ_cont. According to an alternative method, a different estimate of the road friction coefficient, which is also valid for the nonlinear region, is used as output value μ_cont if it is decided that the current slope k_op is within the nonlinear region of the curve 30.

In the third computational thread 42 an estimate for the maximum available road surface friction μ_max is computed in a step 48. Unless the vehicle does not make use of the maximum available road surface friction, the maximum available road surface friction cannot be measured and must be determined by an estimate. In the fourth computational thread 43, an estimate for the minimum available road surface friction μ_min is computed in a step 49. Estimates for minimum and maximum available road surface friction can be obtained from a grip margin which is defined as

$${M}_{grip} = \frac{{μ}_{SAT} - \frac{\vert \ddot{y} \vert}{g}}{{μ}_{SAT}} ,$$

Where μ SAT is an estimate of the road friction coefficient based on the self aligning torque, |ÿ| is the magnitude of a lateral acceleration and g is the standard gravitational acceleration. Instead of the lateral acceleration, the longitudinal or the vector sum of lateral and longitudinal acceleration may be used. The grip margin M_{grip}, is a measure for the usage of the available road surface friction μ and is close to zero if the usage is high and close to one if the usage is low.

According to a first method, the minimum and maximum available road friction coefficient are determined by setting positive and negative error margins around the estimated road friction coefficient μ_SAT. The error margins are set narrow for a small grip margin and the error margins are set narrow for a large grip margin. According to a second method, estimates for the minimum and maximum available road surface friction coefficients are computed from the lateral acceleration via the relations

$${μ}_{max} = \frac{1}{1 - {M}_{grip}} = \frac{g}{\vert \ddot{y} \vert}$$

$$and$$

$${μ}_{min} = 1 - {M}_{grip} = \frac{\vert \ddot{y} \vert}{g} = \frac{1}{{μ}_{max}} .$$

In an alternative to this method, lower and upper limits are computed according to

$${μ}_{max} = {μ}_{SAT} + {k}_{upper} ( \frac{g}{\vert \ddot{y} \vert} - {μ}_{SAT} )$$

$$and$$

$${μ}_{min} = {μ}_{SAT} - {k}_{lower} ( {μ}_{SAT} - \frac{\vert \ddot{y} \vert}{g} )$$

to obtain closer limits. Herein, k_upper and k_lower are adjustment factors. The adjustment factors may be constants or may also be dependent on sensor output values.

If the estimate μ_cont of decision step 47 is smaller than the minimum available road surface friction coefficient μ_min, it is set to the minimum available road surface friction coefficient μ_min in step 50. If, on the other hand, the estimate μ_cont is greater than the maximum available road surface friction coefficient μ_max it is set to the maximum available road surface friction coefficient μ_max in step. The final value μ=min(max(μ_cont, μ_min), μ_max) is output as final estimate μ_SAT of the self aligning torque. If the minimum and maximum available road surface friction coefficient are not determined as often as the estimate μ_cont, a forget function can be applied to the lower estimate μ_min and the upper estimate μ_max which widens the gap between the lower estimate μ_min and the upper estimate μ_max over time.

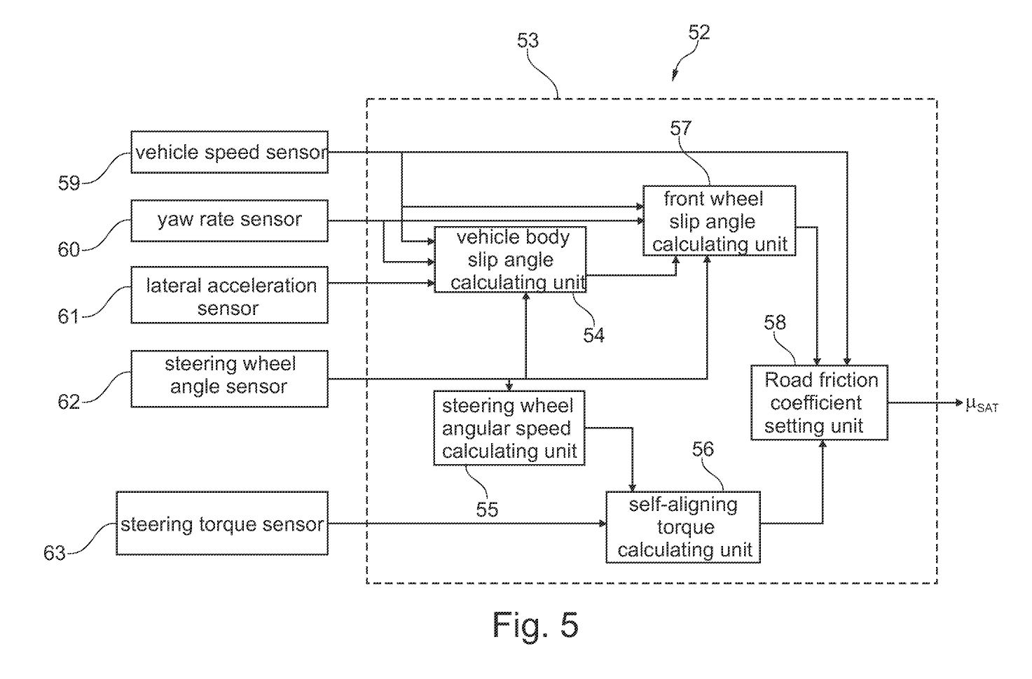

FIG. 5 shows a road friction coefficient estimating apparatus 52 for a vehicle 10 in which the estimation of a road friction coefficient is carried out. A control unit 53 of the road friction coefficient estimating apparatus comprises a vehicle body slip angle calculating unit 54 and a steering wheel angular speed calculating unit 55 which are connected to outputs of sensors. Furthermore, the control unit 53 comprises also a self aligning torque calculating unit 56 and a front wheel slip angle calculating unit 57 which are connected to outputs of sensors and to outputs of the units 54 and 55. The control unit 53 comprises a road friction coefficient setting unit 58 in which the computations of FIG. 4 are carried out. The road friction coefficient setting unit 58 is connected to outputs of the self-aligning torque calculating unit 56, of the front wheel slip angle calculating unit 57 and of a vehicle speed sensor 59.

The front wheel slip angle calculating unit 57, in turn, is connected to outputs of the vehicle body slip angle calculating unit 54, of the vehicle speed sensor 59, of a yaw rate sensor 60 and of a steering wheel angle sensor 62 of an electronic power steering. The vehicle body slip angle calculating unit, in turn, is connected to outputs of the vehicle speed sensor 59, of the yaw rate sensor 60 and of the lateral acceleration sensor 61.

The self-aligning torque calculating unit 56 is connected to an output of the steering wheel angular speed calculating unit 55 and to an output of a steering torque sensor 63 of an electronic power steering, which measures the steering torque at the lower part of a steering column. The steering wheel angular speed calculating unit, in turn, is connected to an output of the steering wheel angle sensor 62.

The self aligning torque calculating unit 56 may also receive input from a steering wheel torque sensor. For a hydraulic power steering, as mentioned above, it may receive input from pressure sensors.

The control unit 53 comprises a microcontroller. The units 54, 55, 56, 57, 58 may be realized in hardware as dedicated circuits or also entirely or partially as parts of a computer executable code.

According to the application, an estimate of the road surface friction coefficient may be used which is based on a measurement of the self aligning torque alone. Further measurements are not required although they may be used in addition.

A method according to embodiments of the present application allows a substantially continuous computing of an estimate of a road friction coefficient. This allows for a rapid adaptation to changing road conditions. As long as the slip angle is small enough, the relationship between self aligning torque and slip angle is approximately linear and a linear estimate is used. The linear estimate provides a reliable computation of the road friction coefficient.

Existing sensors of a power steering can be used for the measurement of the self aligning torque. Therefore the computation method for the road surface friction coefficient is cheap to implement. Computational errors are reduced as compared to an estimation method based on motion sensors only.

The use of a Kalman filter allows compensation for random contributions which are due to the tire road interaction, the steering mechanism or the measurement process. As shown in FIG. 2, the random contributions can be considerable. Other filters, such as a weighted moving average filter or various types of noise filters, may also be used, however.

The method for estimation of the road surface friction coefficient may be implemented in different ways. It may be stored as executable program or be realized as a hardwired circuit. The executable program may be stored on any computer readable medium such as a read only memory, a flash memory or an EPROM. The computer readable medium may be part of an electronic control unit which is used in a vehicle control system such as an electronic stability program (ESP), an anti-lock braking system (ABS), an active steering system, etc. According to the application, the vehicle control system uses the estimated road friction coefficient to control actuators such as breaks, clutches, hydraulic or electric actuators of a power steering or also to control the acceleration of a car engine.

The computational threads of FIG. 4 may be carried out in parallel, through multitasking, or in a combination of both. For example, a scheduler may assign the computational threads to one or more processors depending on the processor loads.

The instructions of the computational threads may also be realized partially or entirely by sequential instructions of a computer readable code instead.

According to an alternative method, the computational thread 40 is restarted instead of resumed when it is decided that the linear region has been entered again. The Kalman filter is then reinitialized and previous estimates are discarded.

In the linearity estimation step, the quotient of finite differences of the self aligning torque and of the slip angle, such as the quotient

$$\frac{M\_z ( t + 1 ) - M\_z ( t )}{α ( t + 1 ) - α ( t )}$$

of two-point differences, may be used as input value for the update formula of a filter, such as a Kalman filter, to estimate the current slope k_op.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for estimating a road surface friction between a road surface and a tire of a vehicle, comprising the steps of:
computing in a slope estimation step, a slope estimate k_sl for a slope of a linear region of a self aligning torque function, the self aligning torque function being defined by a self aligning torque as a function of a slip angle;
deriving a first estimate μ_sl of a road friction coefficient μ from the slope estimate k_sl;
deciding, in a linearity estimation step, whether a current slope k_op is within the linear region of the self aligning torque function; and
outputting the first estimate μ_sl of the road friction coefficient as a second estimate μ_cont of the road friction coefficient if it is decided in the linearity estimation step that the current slope k_op is within the linear region of the self aligning torque function.

2. The method according to claim 1, further comprising the step of halting the computation of the slope estimate k_sl if it is decided in the linearity estimation step that the current slope k_op is not within the linear region of the self aligning torque function.

3. The method according to claim 1, wherein the linearity estimation step comprises a computation of a time derivative of the self aligning torque and of the time derivative of the slip angle.

4. The method according to claim 1, wherein in the linearity estimation step it is decided that the current slope k_op is within a nonlinear region of the self aligning torque function if k_op falls below a lower threshold k_op_threshold_low and it is decided that the current slope k_op is within the linear region of the self aligning torque function if the current slope k_op rises above an upper threshold k_op_threshold_high, wherein k_op_threshold_low<k_op_threshold_high.

5. The method according to claim 1, wherein the slope estimation step comprises a computation of a quotient from the self aligning torque and the slip angle.

6. The method according to claim 1, wherein the slope estimation step comprises computing estimates of one or more observation variables by an update formula of a Kalman filter.

7. The method according to claim 1, wherein the linearity estimation step comprises computing estimates of one or more observation variables by an update formula of a Kalman filter.

8. The method according to claim 7, wherein the one or more observation variables are given by a time derivative of the self aligning torque and the time derivative of the slip angle.

9. The method according to claim 1, wherein the slope estimation step and the linearity estimation step are executed as computational threads.

10. The method according to claim 1, further comprising the steps of:
comparing the second estimate μ_cont of the road friction coefficient to a lower limit;
comparing the second estimate μ_cont of the road friction coefficient to an upper limit;
outputting as a final estimate μ_SAT of the road friction coefficient the second estimate μ_cont if the second estimate is within a range defined by the upper limit and the lower limit and outputting the lower limit if the second estimate μ_cont is less than the lower limit and outputting the upper limit if the second estimate μ_cont is greater than the upper limit.

11. The method according to claim 10, wherein the upper limit is derived from a maximum available road friction μ_max and the lower limit is derived from a minimum available road friction μ_min, a first derivation of the upper limit comprises a computation of a forget function of the maximum available road friction μ_max and a second derivation of the lower limit comprises a computation of the forget function of the minimum available road friction μ_min and the forget function is defined such that a difference between the lower limit and the upper limit increases with time.

12. A computer readable medium embodying a computer program product, said computer program product comprising:
a program for estimating a road surface friction between a road surface and a tire of a vehicle program, the program configured to:
compute in a slope estimation step, a slope estimate k_sl for a slope of a linear region of a self aligning torque function, the self aligning torque function being defined by a self aligning torque as a function of a slip angle;
derive a first estimate μ sl of a road friction coefficient μ from the slope estimate k_sl;
decide, in a linearity estimation step, whether a current slope k_op is within the linear region of the self aligning torque function; and
output the first estimate μ_sl of the road friction coefficient as a second estimate μ_cont of the road friction coefficient if it is decided in the linearity estimation step that the current slope k_op is within the linear region of the self aligning torque function.

13. The computer readable medium embodying the computer program product of according to claim 12, said program further configured to halt the computation of the slope estimate k_sl if it is decided in the linearity estimation step that the current slope k_op is not within the linear region of the self aligning torque function.

14. The computer readable medium embodying the computer program product of according to claim 12, wherein the linearity estimation step comprises a computation of a time derivative of the self aligning torque and of the time derivative of the slip angle.

15. The computer readable medium embodying the computer program product of according to according to claim 12, wherein in the linearity estimation step it is decided that the current slope k_op is within a nonlinear region of the self aligning torque function if k_op falls below a lower threshold k_op_threshold_low and it is decided that the current slope k_op is within the linear region of the self aligning torque function if the current slope k_op rises above an upper threshold k_op_threshold_high, wherein k_op_threshold_low<k_op_threshold_high.

16. The computer readable medium embodying the computer program product of according to claim 12, wherein the slope estimation step comprises a computation of a quotient from the self aligning torque and the slip angle.

17. The computer readable medium embodying the computer program product of according to according to claim 12, wherein the slope estimation step comprises computing estimates of one or more observation variables by an update formula of a Kalman filter

18. The computer readable medium embodying the computer program product of according to according to claim 12, wherein the linearity estimation step comprises computing estimates of one or more observation variables by an update formula of a Kalman filter.

19. The computer readable medium embodying the computer program product of according to according to claim 18, wherein the one or more observation variables are given by a time derivative of the self aligning torque and the time derivative of the slip angle.

20. The computer readable medium embodying the computer program product of according to according to claim 12, wherein the slope estimation step and the linearity estimation step are executed as computational threads.

21. The computer readable medium embodying the computer program product of according to according to claim 12, the program further configured to:
compare the second estimate μ_cont of the road friction coefficient to a lower limit;
compare the second estimate μ_cont of the road friction coefficient to an upper limit; and
output as a final estimate μ_SAT of the road friction coefficient the second estimate μ_cont if the second estimate is within a range defined by the upper limit and the lower limit and outputting the lower limit if the second estimate μ_cont is less than the lower limit and outputting the upper limit if the second estimate μ_cont is greater than the upper limit.

22. The computer readable medium embodying the computer program product of according to according to claim 21, wherein the upper limit is derived from a maximum available road friction μ_max and the lower limit is derived from a minimum available road friction μ_min, a first derivation of the upper limit comprises a computation of a forget function of the maximum available road friction μ_max and a second derivation of the lower limit comprises a computation of the forget function of the minimum available road friction μ_min and the forget function is defined such that a difference between the lower limit and the upper limit increases with time.
